(19) United States
(12) Patent Application Publication
(10) Pub. No.: US 2022/0145669 A1
(43) Pub. Date: May 12, 2022

(54) CUSTOMIZABLE STORAGE CABINET

(71) Applicant: WERNER CO., Greenville, PA (US)

(72) Inventors: Sang Oh, Lake Zurich, IL (US); Michael Gong, Elk Grove Village, IL (US)

(21) Appl. No.: 17/500,354

(22) Filed: Oct. 13, 2021

Related U.S. Application Data
(60) Provisional application No. 63/110,514, filed on Nov. 6, 2020.

(51) Int. Cl. E05B 65/52; A47B 97/00; A47B 47/00; A47K 1/08

(52) U.S. Cl. CPC E05B 65/52; A47B 97/00; A47K 2210/00; A47K 1/08; A47B 2220/0072; A47B 47/00

(57) ABSTRACT

A customizable storage cabinet is disclosed. In one embodiment, the storage cabinet includes a rear wall and two side walls extending upwardly from a bottom wall to define a storage space, at least one door secured to one of the side walls by a removable fastening mechanism, and a locking mechanism secured to the at least one door. The at least one door is configured to be removed or exchanged.

### CROSS-REFERENCE TO RELATED APPLICATIONS

This application claims priority to U.S. Provisional application No. 63/110,514 filed on Nov. 6, 2020, the entire contents of which are incorporated herein by reference.

### BACKGROUND

### A. Field

This disclosure relates generally to storage cabinets, and more particularly to a jobsite storage cabinet that can be customized.

### B. Description of Related Art

Work site or jobsite storage cabinets are used to store a variety of items, including tools, electronic instruments, measuring devices, and supplies for use on the job. Known cabinets generally include one or more doors, and a center post having a locking system or mechanism to lock the doors thereto. The center post somewhat restricts access to the cabinet interior. Additionally, the doors are connected to the cabinet using welded piano hinges, which make eliminate the possibility of removing or exchanging door types on the cabinet.

### SUMMARY

The following embodiments and aspects thereof are described and illustrated in conjunction with systems, tools and methods which are meant to be exemplary and illustrative, not limiting in scope.

In one aspect, a customizable storage cabinet is disclosed. The storage cabinet includes a top wall and a bottom wall, a rear wall, a first side wall and a second side wall, each extending between the top wall and the bottom wall to define a storage space, at least one door secured to one of the side walls by at least one removable fastening mechanism, and a locking mechanism secured to the at least one door. The at least one door is configured to be removed or exchanged.

In another aspect, a storage container includes a top wall and a bottom wall, a rear wall, a first side wall, and a second side wall, each extending between the top wall and the bottom wall to define a storage space, a first door secured to the first side wall by a plurality of removable fastening mechanisms, wherein the first door comprises a first upper compartment and a first lower compartment, a second door secured to the second side wall by a second plurality of removable fastening mechanisms, wherein the second door comprises a second upper compartment, a ventilated section, and a handle, and a locking mechanism secured to the second door, wherein the locking mechanism locks the first door to the second door when is the doors are in a closed position. The first door and the second door are each configured to be removed or exchanged.

In another aspect, a process for customizing a storage container includes providing a storage container having at least one door, the at least one door is secured by a plurality of removable fastening mechanisms, removing the at least one door from the storage container via the removable fastening mechanism, and replacing the at least one door with a substitute door.

In addition to the exemplary aspects and embodiments described above, further aspects and embodiments will become apparent by reference to the drawings and by study of the following detailed description.

### BRIEF DESCRIPTION OF THE DRAWINGS

Exemplary embodiments are illustrated in the drawings. It is intended that the embodiments and figures disclosed herein are to be considered illustrative rather than restrictive.

FIG. 1A is a perspective view of an example storage cabinet with solid doors in accordance with an embodiment;

FIG. 1B shows the storage cabinet of FIG. 1A with the doors in the open position;

FIG. 2 is a close-up view of an example locking mechanism for use with the storage cabinet in accordance with an embodiment;

FIG. 3A is a perspective view of the storage cabinet shown in FIG. 1 with ventilated doors in accordance with an embodiment;

FIG. 3B shows the storage container of FIG. 3A with the doors in the open position;

FIG. 3C shows a close-up view of the fastening mechanism attaching the door to the side wall;

FIG. 4 is a perspective view of the storage cabinet shown in FIG. 1 with compartmented doors in accordance with an embodiment;

FIG. 5 shows a use for the compartmented doors on the cabinet shown in FIG. 4; and

FIG. 6 shows the cabinet with different door options for use with the storage cabinet in accordance with an embodiment.

### DETAILED DESCRIPTION

A customizable storage cabinet is disclosed. The storage cabinet does not have a center locking post, but instead has the door locking mechanism mounted on one of the two doors. Also, the storage cabinet includes interchangeable doors which may be removed by simply lifting the open door off the hinges, and replacing it with another door having different functionalities/features. Example features and functionalities of doors may include, but are not limited to, solid doors for maximum security and content protection, vented or perforated doors to allow for ventilation of stored harness equipment, doors with built-in compartments accessible from the outside which can house safety equipment such as first aid kits, extinguishers, eye wash equipment, etc., for quick access, doors with transparent panels to allow viewing of the cabinet contents, doors that protrude beyond the front face of the cabinet in order to provide added internal cabinet storage capacity, and doors having wash station components such as a sink and faucet. It should be understood that other types of doors designed for a specific purpose may also be used, all of which may be easily removed and installed onto the basic cabinet. Additionally, door types may be mixed on a single cabinet if desired.

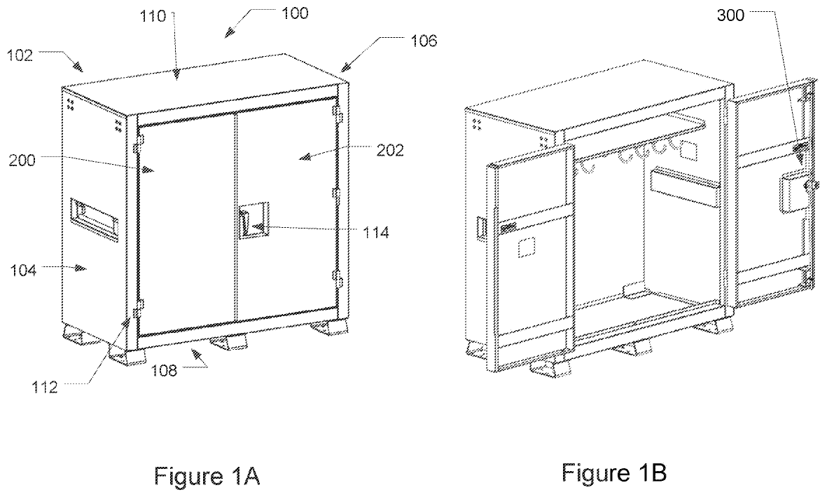

Referring to FIGS. 1A and 1B, an example customizable storage cabinet 100 is disclosed. The storage cabinet 100 includes a rear wall 102 and two side walls 104, 106 extending from a bottom wall 108. The storage cabinet 100 also includes a top wall 110.

At least one door is secured to one of the side walls. As shown in FIG. 1, two solid doors 200 and 202 are secured to side walls 104, 106. In some embodiments, as described below, the doors may include vents, compartments, may be perforated, transparent, etc. The doors 200, 202 are secured to the side walls 104, 106 via a plurality of removable fastening mechanisms 112, so the doors may be easily removed or exchanged. In one example, the fastening mechanism may comprise vault-type hinges. In other embodiments, other known fastening mechanisms could be used.

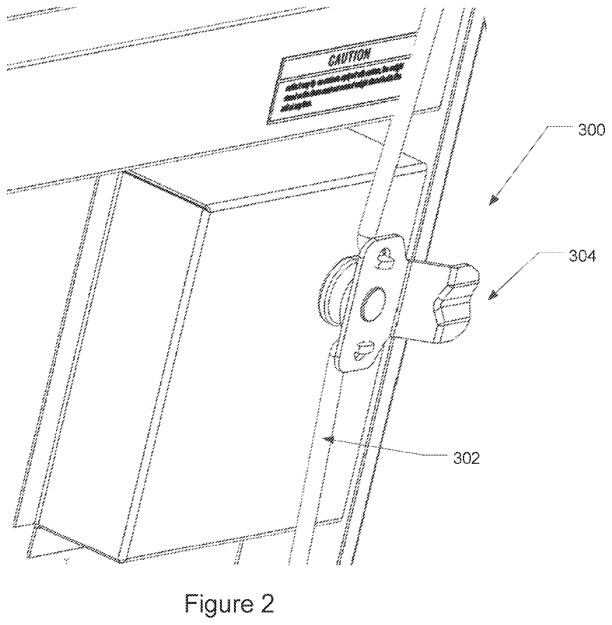

In some embodiments, one of the doors 200 includes an actuator 114, such as a handle, for opening the door and obtaining access to the interior of the storage container 100. In some embodiments, the door 200 may further include a locking or latching mechanism 300 mounted on the side of the door facing the interior of the storage container 100. In some embodiments, the locking mechanism 300 may be a 3-point latching handle, and includes a latch rod 302 and a locking member 304, as shown in FIG. 2. When the handle 114 is turned, the locking member 304 rotates to unlock the door 200 and allow the door to open. It should be understood that any known locking or latching mechanism may be used to maintain the doors 200, 202 of the cabinet in the closed position.

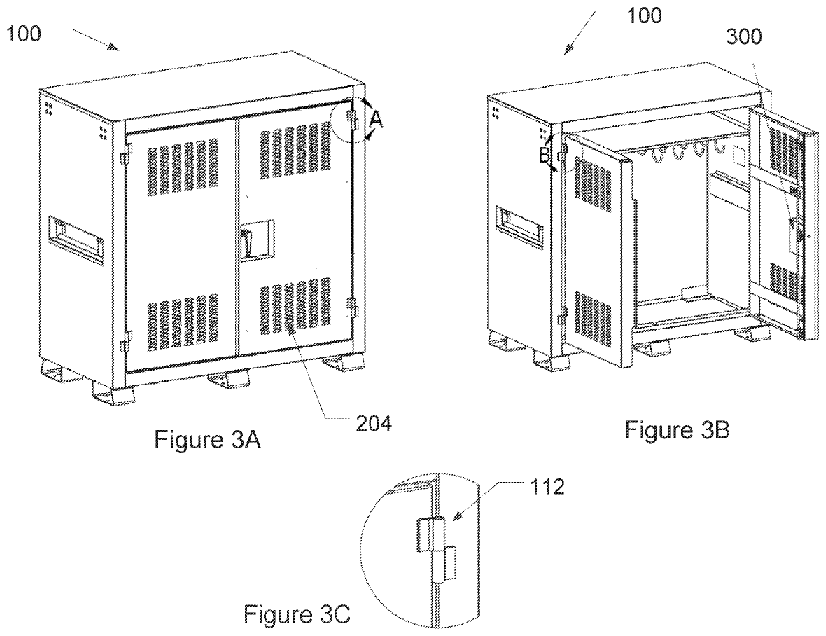

FIGS. 3A and 3B show the storage cabinet 100 with ventilated doors. The doors 200, 202 may include one or more vented areas 204 to allow the circulation and passage of air therethrough and to the interior of the cabinet 100. FIG. 3A shows the doors in the closed position, and FIG. 3B shows the doors in the open position.

FIG. 3C shows a close-up view of the fastening mechanism 112 (vault-type hinge) used to secure the doors 200, 202 to the side walls 104, 106.

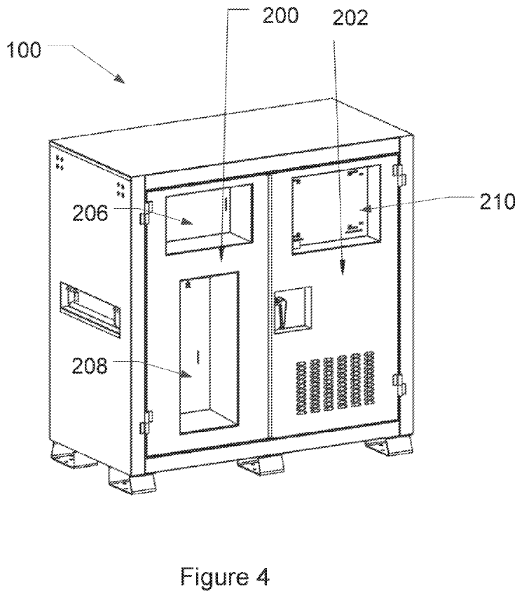

FIG. 4 shows another embodiment of the storage cabinet 100 with doors 200, 202 having a plurality of compartments 206, 208, and 210. The compartments may be used to hold supplies and equipment for easy access. It should be understood that in some embodiments, any number of compartments may be positioned on one or both of the doors 200, 202.

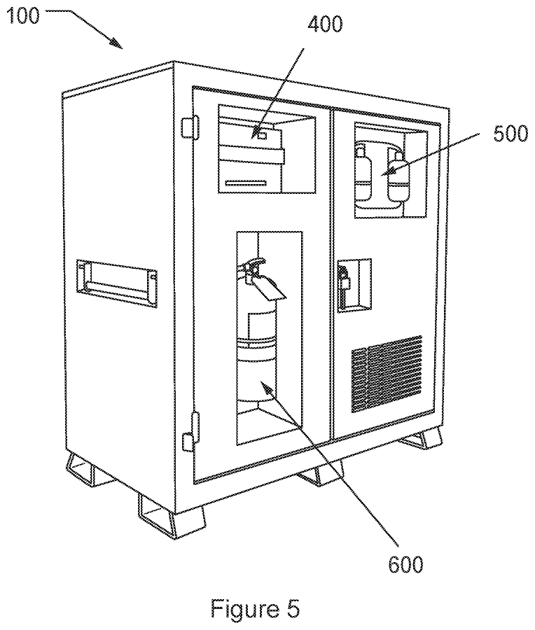

As shown in FIG. 5, a first aid kit 400, eye wash equipment 500, and a fire extinguisher 600 are shown in positions of compartments which allow quick access in emergencies.

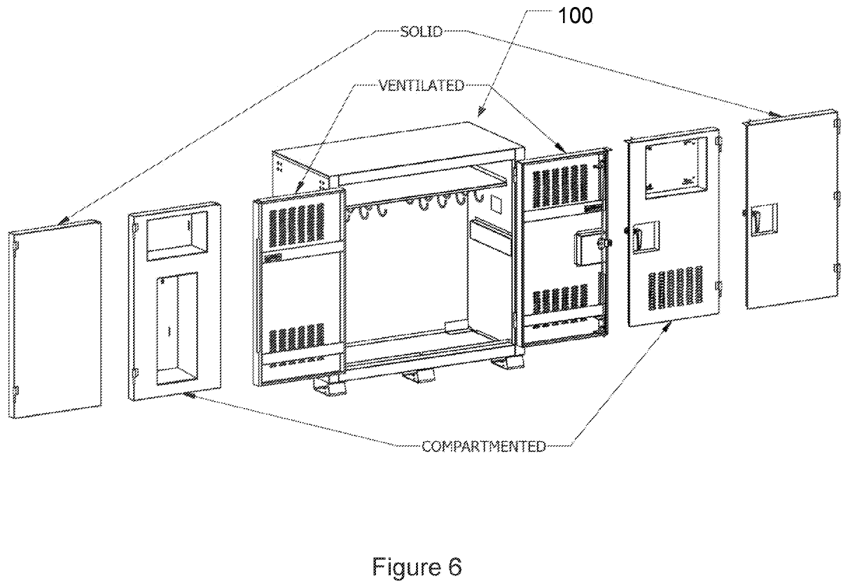

In operation, to remove or exchange the doors 200, 202, the fastening mechanism 112 is released/opened/removed to allow the door(s) to easily detach from the side walls 104, 106. Different doors with similar fastening mechanisms may then be attached to the side walls 104, 106. FIG. 6 shows that solid, ventilated, and compartmented doors may all be used with the same storage cabinet 100.

The present application provides a number of advantages, including the absence of a center post, which permits easier access to the cabinet interior.

A single cabinet body 100 may be sold with one type of doors, and allows the customer to later replace those doors with doors of a different type/feature/functionalities as needed.

While a number of exemplary aspects and embodiments have been discussed above, those of skill in the art will recognize that still further modifications, permutations, additions and sub-combinations thereof of the features of the disclosed embodiments are still possible. It is therefore intended that the following appended claims and claims hereafter introduced are interpreted to include all such modifications, permutations, additions and sub-combinations as are within their true spirit and scope.

1. A storage container, comprising:
a top wall and a bottom wall;
a rear wall, a first side wall and a second side wall, each extending between the top wall and the bottom wall to define a storage space;
at least one door secured to one of the side walls by at least one removable fastening mechanism; and
a locking mechanism secured to the at least one door;
wherein the at least one door is configured to be removed or exchanged.

2. The storage container of claim 1, wherein the storage container does not comprise a center post extending from the bottom wall.

3. The storage container of claim 1, wherein the at least one door includes a first door secured to the first side wall and a second door secured to the second side wall, wherein the locking mechanism is configured to lock the first door and the second door when each door is oriented in a closed position.

4. The storage container of claim 1, wherein the at least one door includes an actuator disposed to allow access to an interior of the storage container.

5. The storage container of claim 1, wherein the at least one door comprises a solid structure.

6. The storage container of claim 1, wherein the at least one door comprises a transparent material.

7. The storage container of claim 1, wherein the at least one door comprises one or more vented areas configured to allow the passage of air therethrough and to an interior of the storage container.

8. The storage container of claim 1, wherein the at least one door comprises a structure that protrudes beyond the face of the storage container when the at least one door is oriented in a closed position.

9. The storage container of claim 1, wherein the at least one door includes a plurality of compartments.

10. The storage container of claim 1, wherein the at least one door includes at least one compartment.

11. The storage container of claim 10, wherein the at least one compartment includes a hand washing station comprising a sink, a faucet, or a soap dispenser.

12. The storage container of claim 10, wherein the at least one compartment contains a first-aid kit, eye wash equipment, or a fire extinguisher.

13. The storage container of claim 1, wherein the at least one removable fastening mechanism includes a plurality of removable fastening mechanisms.

14. The storage container of claim 13, wherein the plurality of removable fastening mechanisms comprise vault hinges.

15. The storage container of claim 1, wherein the locking mechanism comprises a three-point latching handle including a latch rod and a locking member.

16. A storage container, comprising:
a top wall and a bottom wall;
a rear wall, a first side wall, and a second side wall, each extending between the top wall and the bottom wall to define a storage space;
a first door secured to the first side wall by a plurality of removable fastening mechanisms, wherein the first door comprises a first upper compartment and a first lower compartment;
a second door secured to the second side wall by a second plurality of removable fastening mechanisms, wherein the second door comprises a second upper compartment, a ventilated section, and a handle; and
a locking mechanism secured to the second door, wherein the locking mechanism locks the first door to the second door when is the doors are in a closed position;
wherein the first door and the second door are each configured to be removed or exchanged.

17. The storage container of claim 16, wherein the first upper compartment is disposed horizontally and the first lower compartment is disposed vertically.

18. The storage container of claim 16, wherein the plurality of removable fastening mechanisms comprise vault hinges.

19. The storage container of claim 16, wherein the storage container does not comprise a center post extending from the bottom wall between the first door and the second door.

20. A process for customizing a storage container, comprising:
providing a storage container having at least one door, wherein the at least one door is secured by a plurality of removable fastening mechanisms;
removing the at least one door from the storage container via the removable fastening mechanism; and
replacing the at least one door with a substitute door.
